(19) United States
(12) Patent Application Publication
(10) Pub. No.: US 2003/0007705 A1
(43) Pub. Date: Jan. 9, 2003

(54) Bearing arrangement for turbo-machines

(76) Inventors: Werner Bosen, Koln (DE); Martin Leonhard, Bruhl (DE)

Correspondence Address: COLLARD & ROE, P.C., 1077 Northern Boulevard, Roslyn, NY, 11576-1696, US

(21) Appl. No.: 09/953,790

(22) Filed: Sep. 17, 2001

(30) Foreign Application Priority Data
Jul. 6, 2001 (EP) 01 116 418.3

(51) Int. Cl. F16C 27/00

(52) U.S. Cl. 384/99

(57) ABSTRACT

A bearing arrangement for turbo-machines containing a bearing housing, a rotor mounted on a rotor shaft in an overhung position, and a roller bearing set. The roller bearing set contains at least two roller bearings arranged on a one-part cylindrical bearing carrier with a minimum installed clearance. The bearing carrier is inserted into a bearing bore of the bearing housing leaving a radial installed gap that permits dampened movements of vibration. The carrier is supported on the peripheral side of the bore with initially tensioned, elastic vibration damping elements.

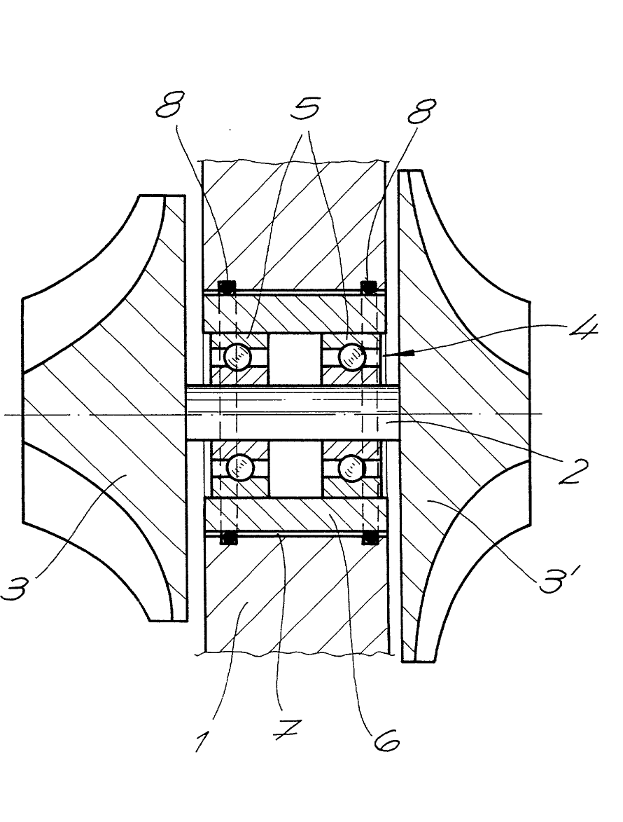

### BACKGROUND OF THE INVENTION

1. Field of the Invention

The invention relates to a bearing arrangement for turbo-machines having a bearing housing, a rotor mounted in an overhung position on a rotor shaft, and a set of roller bearings arranged on a one-part cylindrical bearing carrier.

2. The Prior Art

High-precision bearings are used as antifriction bearings for high-speed turbo-rotors that produce only low friction loss at the highest number of revolutions. With high-precision roller bearings, the product of the number of revolutions and the pitch diameter may be up to 2.5×10⁶ mm/min. Bearing arrangements having high-precision roller bearings permit large expansion pressure ratios in the turbine stage, for example when used with cold turbo-expanders. However, bearing arrangements having a set of roller bearings with high-precision roller bearings have an acceptable useful life only if they are adequately dampened when passing through critical numbers of revolution when the turbo-machine is starting or running out. Furthermore, the roller bearings have to be installed with a minimum clearance and with exclusion of any alignment errors during installation. Even very minor alignment or clearance errors that permit relative movements of the rolling bearings substantially reduce the useful life and destroy the function of such bearings.

### SUMMARY OF THE INVENTION

An object of the present invention is to provide a bearing arrangement comprised of a set of high-precision roller bearings for the rotor shafts of a turbo-machine operating at high speed. The roller bearings are aligned with each other with as little installed clearance as possible and with the exclusion of installed alignment errors. Furthermore, provision is made for effective damping of the bearings, and damage to the roller bearing is prevented when operated at a critical number of revolutions of the engine.

These and other objects are accomplished by providing the set of roller bearings arranged in a one-part cylindrical bearing carrier with minimum installed play. The bearing carrier is inserted into a bearing bore of the bearing housing with a radial installed gap that permit dampened movements of vibration. The carriers supported on the peripheral side of the above and contains initially tensioned, elastic vibration damping elements. The bearing carrier, which receives the complete set of roller bearings, is a comparatively lightweight but dimensionally stable cylindrical structural component that is arranged with radial play in the bore of the bearing housing. The carrier is fixedly connected to the other stator components of the turbo-machine. The installed gap permits radial movements between the bearing carrier and the bore of the bearing housing and is used for damping vibrations. According to a preferred embodiment of the present invention, elastomer rings are provided between the bearing carrier and the bearing housing as vibration damping elements. These elastomer rings bridge the installed gap and assure an adequate concentric alignment between the cylindrical bearing carrier and the bore of the bearing housing and consequently also between the rotor and the stator of the turbo-machine. Furthermore, the elastomer rings dampen vibrations that occur when the rotor shaft of the turbo-machine runs through a critical range of number of revolutions when it is started and shut down. The damping effect can be varied by the number of the elastomer rings, through the hardness of the elastomer rings, as well as by the dimensions of the elastomer rings.

The damping effect of the initially tensioned, elastic vibration damping elements can be reinforced by providing the installed gap with damping fluid. According to another embodiment, an oil filling is provided in the installed gap between the bearing carrier and the housing. The oil filling is sealed from the outside by the elastomer rings. The gap may also have one or more ring channel-shaped recesses for receiving the damping fluid. The damping behavior can be optimized by the fluid cushion. The rotor may be the rotor of a turbo-expander that is mounted in an overhung position on one end of the rotor shaft, whereas the other end of the shaft located on the driven side is fitted with the rotor of a compressor, or drives a generator. The rotor may also be a compressor rotor of a turbo-compressor that is connected in an overhung position on the end of a rotor shaft located on the driven side. The end of the shaft on the driving side is connected with a motor via a coupling, or is designed as the rotor of a directly connected electric motor, or is fitted with a toothed gear of a transmission.

### BRIEF DESCRIPTION OF THE DRAWING

Other objects and features of the present invention will become apparent from the following detailed description considered in connection with the accompanying drawing. It is to be understood, however, that the drawing is designed as an illustration only and not as a definition of the limits of the invention.

The drawing shows a bearing arrangement for a turbo-machine.

### DETAILED DESCRIPTION OF THE PREFERRED EMBODIMENT

The bearing arrangement contains a bearing housing 1, a rotor shaft 2 with at least one rotor 3 or 3′ arranged in an overhung position. A roller bearing set 4 contains at least two high-precision roller bearings mounted on rotor shaft 2. In a preferred embodiment, rotor 3 for an expansion turbine stage is connected to one end of the shaft of the rotor shaft 2, and a compressor rotor 3′ of a turbo-compressor stage is connected to the other end of the shaft.

Roller bearing set 4 is disposed in a one-part cylindrical bearing carrier 6 with a minimum installed clearance. Bearing carrier 6 is inserted into a bearing bore of the bearing housing 1 with a radial installed gap 7 that permits dampened movements of vibration. Carrier 6 is supported on the peripheral side on the initially tensioned, elastic vibration damping elements 8. In another preferred embodiment, vibration damping elements 8 comprise elastomer rings arranged between the bearing carrier 6 and the bearing housing 1 and bridges installed gap 7. Installed gap 7 may also contain a damping fluid. In another embodiment, installed gap 7 comprises one or more ring channel-shaped recesses for receiving the damping fluid. Viscous fluids, such as oils are suitable damping fluids.

Accordingly, while only a few embodiments of the present invention have been shown and described, it is obvious that many changes and modifications may be made thereunto without departing from the spirit and scope of the invention.

What is claimed is:

1. A bearing arrangement for turbo machines, comprising:
a bearing housing;
a rotor shaft;
a one-part cylindrical bearing carrier inserted into a bearing bore of the bearing housing, wherein a radial installed gap permits dampened movements of vibration; and wherein the carrier is supported on a peripheral side of initially tensioned elastic vibration damping elements;
a rotor mounted in a overhung position on the rotor shaft;
a roller bearing set mounted on the rotor shaft, the roller bearing set comprising: at least two roller bearings arranged in the cylindrical bearing carrier with a minimum clearance.

2. The bearing arrangement according to claim 1, further comprising elastomer rings arranged between the bearing carrier and the bearing housing as vibration damping elements for bridging the installed gap.

3. The bearing arrangement according to claim 1, wherein the installed gap contains a damping fluid.

4. The bearing arrangement according to claim 3, wherein the installed gap comprises at least one ring channel-shaped recesses for receiving the damping fluid.
